(19) United States
(12) Patent Application Publication
(10) Pub. No.: US 2006/0115506 A1
(43) Pub. Date: Jun. 1, 2006

(54) Compositions and method of wood preservation

(76) Inventors: Mark A. Harmer, Kennett Square, PA (US); Weiming Qiu, Wilmington, DE (US); Zhixiong Xue, Chadds Ford, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/000,162

(22) Filed: Nov. 30, 2004

(51) Int. Cl. A01N 43/64; A01N 25/32; A01N 43/50

(52) U.S. Cl. 424/406; 514/229.2; 514/383; 514/397; 977/902; 514/254.07; 514/235.5

(57) ABSTRACT

This invention provides a method for preserving wood by treating the wood with a composition comprising a dispersion of colloidal silica or colloidal alumina particles in a solvent and one or more organic biocides.

### FIELD OF THE INVENTION

This invention provides a method for preserving wood by treating the wood with a composition comprising a dispersion of colloidal particles in a solvent and one or more organic biocides.

### BACKGROUND

Major agents of wood decay in untreated wood are fungi and insects. Chromated copper arsenate (CCA) is a commonly used wood preservative that protects wood against attack by wood-rotting fungi and wood-destroying insects. Ammoniacal copper quat (ACQ) and alternative treatments are also used as wood preservatives. Although these compounds are effective and provide long-lasting protection, concerns about the potential health and environmental impact of leachate from the treated wood are curtailing their use.

There is a need for an alternative wood preservative that does not present the potential health and environmental concerns of CCA, ACQ, or other heavy metal-containing compounds and that is effective at low application rates.

### SUMMARY OF THE INVENTION

The invention provides a composition comprising: a dispersion of colloidal particles comprising silica or alumina particles in a solvent; and a biocide comprising an organic fungicide. The composition may further comprise an organic insecticide.

The invention also provides a process for preserving wood comprising contacting wood with a composition comprising: a dispersion of colloidal particles comprising silica or alumina particles in a solvent; and a biocide comprising an organic fungicide.

An embodiment of the process encompasses transporting the composition with a driving force to penetrate the wood. Articles produced by the processes of the invention are also encompassed.

### DETAILED DESCRIPTION OF THE INVENTION

This invention provides a method for preserving wood and protecting it against attack by wood-rotting fungi. The method of this invention is suitable both for combating an acute attack by fungi and for preventive protection against fungi. The method of this invention is suitable for use with many types and forms of wood, including timbers, freshly milled or aged lumber, and a wide variety of hard and soft woods. It can also be used to protect wood products (such as various laminated products, particle board, fiberboard, plywood, and oriented strand board) either by treating the wood before or while it is incorporated into the wood product or by treating the wood product itself.

The invention is practiced by contacting the wood with a composition comprising a dispersion of colloidal particles of silica and/or alumina in a solvent and a suitable organic biocide (e.g., fungicide and/or insecticide).

Colloidal Particles:

Suitable particles for use in the composition of this invention must be small enough to be impregnated into the wood. Particles less than about 1 μm in at least one dimension, preferably less than about 100 nm in at least one dimension, are suitable. Suitable dispersions of colloidal silica particles are commercially available under the trade name, Ludox® (E. I. du Pont de Nemours and Company, Wilmington, Del.). Suitable dispersions of colloidal alumina particles are commercially available under the trade name Nyacol® A120 (Nyacol Nano Technologies, Inc., Ashland, Ma.).

Organic Fungicides:

In an embodiment of this invention, the wood-preserving composition contains a fungicide. The fungicides in the wood-preservative compositions of this invention are selected from the groups of fungicides active against wood-rotting basidiomycetes. The fungicide(s) can comprise one or more fungicides selected from the group of conazoles and ergosterol biosynthesis inhibitors to prevent the growth of white rot, brown rot, and soft rot fungi, which are the major causes of wood decay in untreated wood. Conazoles useful in this invention include climbazole, clotrimazole, imazalil, oxpoconazole, prochloraz, triflumizole, azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, and uniconazole-P. Ergosterol biosynthesis inhibitors useful in this invention include morpholine fungicides such as aldimorph, benzamorf, carbamorph, dimethomorph, dodemorph, fenpropimorph, flumorph, and tridemorph.

Other fungicides that have been found to be effective against one or more wood-rotting fungi include carboxin, iprodione, fenpiclonil, ferbam, fenpiclonil, capafol, 8-hydroxyquinoline, nabam, oxycarboxin, cyprodinil, chlorothanil, axaoxystrobin, trifloxystrobin, thiram, fluazinam, terrazole, carbendazim, and benomyl. These fungicides can be used in combination with one or more conazoles or ergosterol biosynthesis inhibitors in the invention.

Combinations of fungicides that are especially effective are those in which the separate fungicides have different and complementary modes of action. Fungicides as a group are known to exhibit a wide variety of modes of action. These modes of action function as uncouplers, kinase inhibitors, or metal chelators, or are known to affect such metabolic activities as succinate dehydrogenation, respiration, tubulin formation, nucleic acid biosynthesis, cell division, acetaldehyde dehydrogenation, or methionine biosynthesis. For example, the triazole fungicides (e.g., flusilazole, tebuconazole, and propiconazole) function as ergosterol biosynthesis inhibitors. Applicants have found that a conazole (such as flusilazole) in combination with carbendazim (a carbamate that affects tubulin formation) or fenpropimorph (a morpholine that also functions as an ergosterol biosynthesis inhibitor) provide synergistic protection against wood-rotting fungi.

The fungicide is present in the wood preservative formulation at a concentration of from about 1 ppm to 10 wt %. In an embodiment of the invention, the ergosterol biosynthesis inhibitor constitutes at least 50 mole % of the fungicide in the wood preservative formulation.

Insecticides:

In another embodiment of this invention, the wood-preserving composition also contains an insecticide. Suitable insecticides include pyrazolines, indazoles, oxyindazoles, pyrazoline carboxanilides, pyridazines, oxadiazines, tricyclic pyridazines, tricyclic oxadiazines, tricyclic triazines, carbamates, organophosphates (e.g., chlorpyrifos and dichlorvos), fenvalerate, and fipronil.

In a further embodiment, indoxacarb and its metabolite are the insecticide. Indoxacarb is a common name assigned by the International Organization for Standardization (ISO) to methyl (4aS)-7-chloro-2,5-dihydro-2-[[(methoxycarbonyl)[4-(trifluoromethoxy) phenyl]amino]carbonyl] indeno[1,2-e][1,3,4]oxadiazine-4a(3H)-carboxylate. Of note is a mixture of indoxacarb and its inactive (R)-isomer in a ratio from 30:70 to 100:0. Also of note is a 1:1 mixture of indoxacarb and its inactive (R)-isomer. Also of note is a 3:1 mixture of indoxacarb and its inactive (R)-isomer. Of particular note is indoxacarb with less than 5% of its inactive (R)-isomer.

If present, the insecticide is present in the wood preservative formulation at a concentration of from about 1 ppm to 10 wt %.

Solvents:

Suitable solvents include polar organic solvents, water, or mixtures of the foregoing, depending on the process used to apply the wood preservative formulation and the active agent or combination of agents used. Polar organic solvents useful in the invention are those that contain hydroxy, ether, keto, or ester groups. Embodiments of the invention include polar solvents that are alcohols, glycols (e.g., glycoether diacetone alcohol), water-insoluble polyols, and their esters.

Aqueous or organic-aqueous solutions, emulsions, and/or suspensions may be used. To increase or improve the solubility of the active agents in the liquid carrier, emulsifiers or solubilizers may be employed. Suitable additives include fixing agents, softeners, emulsifiers, cross-linking agents, solution mediators, pigments, dyes, anti-corrosion agents, odor correctors, pH-regulators, UV-stabilizers, waxes, and drying oils.

Wood Preserving Method:

In the wood-preserving method of this invention, the wood to be preserved is contacted with a dispersion of colloidal silica or colloidal alumina particles in a suitable solvent and suitable organic fungicide (as described above) and optionally a suitable insecticide (as described above).

In the wood preserving method of this invention, the wood is impregnated with an effective amount of the wood-preserving composition by providing a driving force to transport the particles and the biocide into the wood. This can be done by first subjecting the wood to a vacuum and then contacting the wood with the wood-preserving composition. The order and number of applications of vacuum and composition can be varied and are still within the invention. Alternatively, the wood can be contacted with the wood-preserving composition and then particles are forced into the wood by the application of pressure. Pressure processes are especially useful for large pieces of wood or for wood that will be used in contact with water or moist soil or in areas infested with termites or other wood-destroying insects.

Suitable woods for use in the process of this invention include both softwoods and hardwoods, but softwoods grown for the commercial market usually benefit the most from treatment with a wood preservative. Suitable woods include, but are not limited to, oak, ash, locust, hickory, walnut, beech, birch, maple, pine, fir, spruce, hemlock, larch, red gum and black gum. In one embodiment of this invention, the wood is selected from the group comprising pine, fir, and spruce.

Wood products produced by the process are treated with the composition and the composition is impregnated into the wood before, as, or after the wood is incorporated into an article. Wood products produced by the process include but are not limited to oriented strand board, particle board, fiber board, plywood, laminated veneer lumber, laminated strand lumber, and handboard.

### EXAMPLES

Wood Preserving Compositions

### Example 1

Dispersion of Pluton® and Colloidal Silica

Ludox® Cl (6.7 g, 30 wt %) was diluted with water to 200 g. Pluton® (55 mg, containing 10 mg of flusilazole and 22 mg of fenpropimorph, E. I. du Pont de Nemours and Company, Wilmington, Del.) was added while stirring. Final composition: 1 wt % Si, 50 ppm of flusilazole, and 110 ppm of fenpropimorph.

### Example 2

Dispersion of Pluton® and Colloidal Silica

Ludox® Cl (100 g, 30 wt %) was diluted with water to 499.68 g. Pluton® (0.325 g, containing 59 mg of flusilazole and 131 mg of fenpropimorph) was added while stirring. Final composition: 5 wt % Si, 99 ppm of flusilazole, and 218 ppm of fenpropimorph.

### Example 3

Dispersion of Propiconazole and Colloidal Silica

Ludox® Cl (100 g, 30 wt %) was diluted with water to 569.4 g total weight. An aqueous solution (30 g) of benzyldimethylalkylammonium acetate (6.5 wt %) was added while stirring. Finally, a butanol solution (0.58 g) of propiconazole (concentration 21.8 wt %) was added while stirring. Final composition: 5 wt % Si, 0.325 wt % ammonium acetate, 210 ppm propiconazole. The average size of the alkyl unit in benzyldimethylalkylammonium acetate is C₁₃.

### Comparative Example A

Dispersion of Triphenylborane and Colloidal Silica

Ludox® Cl (6 g, 30 wt %) was diluted with water to 500 g. An aqueous solution (0.80 g) of triphenylborane-sodium hydroxide adduct solution (containing 7.49 wt % Ph₃B) was added while swirling. Water was added to the above mixture to a total weight of 600 g. Final composition: 0.3 wt % Si, 100 ppm triphenylborane.

### Example 4

Dispersion of Tebuconazole and Colloidal Silica

Ludox® LS (100 g, 30 wt %) was diluted with water to 599.52 g. A butanol solution (0.48 g) of tebuconazole (concentration 25.02 wt %) was added while stirring, and then shaking. Final composition: 5 wt % Si, 200 ppm tebuconazole.

### Comparative Example B

Dispersion of Triphenylborane and Colloidal Silica

Ludox® HS30 (5 wt %) and triphenylborane-ammonia adduct (0.151 g) was heated to 100° C. while air was bubbled through the mixture for 1 hr. The majority of the solid (triphenylborane-ammonia adduct) was dissolved in less than 1 hr. This suspension contained 5 wt % Si, 0.3 wt % triphenylborane. Water was added to the above suspension to a total volume of 600 ml. Final composition: 0.42 wt % Si, 250 ppm triphenylborane.

### Comparative Example C

Dispersion of Triphenylborane and Colloidal Alumina

Nyacol® A120 (9 g, 20 wt %) was diluted with water to 590.2 g. An aqueous solution (0.80 g) of triphenylborane-sodium hydroxide adduct solution (containing 7.49 wt % Ph₃B) was added while swirling. Water was added to the above mixture to a total weight of 600 g. Final composition: 0.3 wt % Al, 100 ppm triphenylborane.

### Example 5

Dispersion of Pluton® and Colloidal Alumina

Nyacol® A120 (9 g, 20 wt %) was diluted with water to 599.85 g. Pluton® (0.15 g), which contained flusilazole (27 mg) and fenpropimorph (60 mg) was added while swirling. Final composition: 0.3 wt % Al, 45 ppm of flusilazole, and 100 ppm of fenpropimorph.

### Example 6

Dispersion of Tebuconazole and Colloidal Alumina

Nyacol® A120 (9 g, 20 wt %) was diluted with water to 599.76 g. A butanol solution (0.245 g) of tebuconazole (concentration 24.54 wt %) was added while stirring. Final composition: 0.3 wt % Al, 100 ppm tebuconazole.

### Example 7

Dispersion of Propiconazole and Colloidal Alumina

Nyacol® A120 (18 g, 20 wt %) was diluted with water to a total weight of 598.4 g. Benzyldimethylalkylammonium acetate (1.20 g) was added while stirring. Finally, a butanol solution (0.42 g) of propiconazole (concentration 28.9 wt %) was added while stirring. Final composition: 0.3 wt % Al, 0.2 wt % benzyldimethylalkylammonium acetate, 200 ppm propiconazole. The average size of the alkyl unit in benzyldimethylalkylammonium acetate is C₁₃.

Preservation of Wood

Twenty wood block specimens (¾″ cubes, Southern yellow pine) were weighed and accurately measured. The blocks were placed in a 500 ml spherical flask reactor with a flat ground flange. Curled steel shavings from a steel scrubber were used to separate and weigh down the blocks. A 3-neck top with a flat ground flange was placed on top of the reactor. A vacuum was applied to the reactor for about 30 min. A dispersion of colloidal silica (or colloidal alumina) and biocides (600 g) was added to the reactor in one portion through a drop funnel. Then the reactor was opened to atmosphere. After about 1 hour, the specimens were removed, excess liquid wiped off, and the blocks weighed to determine the weight of colloidal suspension retained.

The biocide-containing colloidal silica- or alumina-treated wood block specimens were evaluated for fungal resistance in one of two ways. In Test Method 1,228 ml French square bottles were each filled with 60 ml of water. Soil (92 g, dried at 105° C. for 2 days) was added. The liners inside the caps were removed. The bottles were autoclaved for 30 min at 121° C. in a liquid cycle, and cooled to room temperature. Wood feeder strips were autoclaved separately at 100° C. in a dry cycle. Test blocks of wood were weighed, dried in a forced draft oven for 18 hrs at 40° C., and weighed again. The drying was continued until a constant weight was achieved (Wb). The wood blocks were then autoclaved at 100° C. in a dry cycle for 30 min. Feeder strips (32 mm by 285 mm by 355 mm) were placed on top of the soil, test blocks laid on top of the feeder strips, and a plug of agar containing the fungus (near the leading edge of the growing mycelia) was placed on top of the feeder strip next to the block. The bottles were then capped loosely. The bottles were placed in the incubator at 24° C. and 75% humidity. After 12 weeks, the blocks were removed from the bottle, dried at 40° C. in the incubator as above for 18 hrs or until a constant weight was achieved (Wa). The weight loss in percentage is calculated as 100×(Wb−Wa)/Wb.

In Test Method 2, the wood blocks were split into four wafers longitudinally. The wafers of the block were substituted for the wood blocks and tested as described in the first method, above.

The results are summarized in the Table. Wood blocks (Southern Yellow Pine) treated with a dispersion of Pluton® and colloidal silica showed good to excellent fungal resistance (Test Method 1). The active ingredient loadings are 0.027 kg/m³ for flusilazole and 0.059 kg/m³ for fenpropimorph.

TABLE
Summary of Results

| | | % Weight | |
|---|---|---|---|
| | | loss after | Test |
| Example | Composition of wood preservative | 3 months | Method |
| Ex. 1 | 1 wt % Si, 50 ppm flu, 110 ppm fen | 2.7 | 1 |
| Ex. 2 | 5 wt % Si, 99 ppm flu, 218 ppm fen | 16.3 | 2 |
| Ex. 3 | 5 wt % Si, 0.325 wt % ben, 210 ppm | 8.2 | 2 |
| | pro | | |
| Comp. Ex. A | 0.3 wt % Si, 100 ppm tpb | 50.7 | 2 |
| Ex. 4 | 5 wt % Si, 200 ppm teb | 31.4 | 2 |
| Comp. Ex. B | 0.42 wt % Si, 250 ppm tpb | 53.0 | 2 |
| Comp. Ex. C | 0.3 wt % Al, 100 ppm tpb | 55.9 | 2 |
| Ex. 5 | 0.3 wt % Al, 45 ppm flu, 100 ppm | 34.8 | 2 |
| | fen | | |
| Ex. 6 | 0.3 wt % Al, 100 ppm teb | 21.5 | 2 |
| Ex. 7 | 0.3 wt % Al, 0.2 wt % ben, 200 ppm | 23.9 | 2 |
| | pro | | |
| Comp. Ex. D | Control, untreated Southern Yellow | 45.7 | 1 |
| | Pine | | |
| Comp. Ex. E | Control, 3% LudoxCl | 40.4 | 1 |

flu = flusilazole;
fen = fenpropimorph;
pro = propiconazole;
teb = tebuconazole;
tpb = triphenylborane;
ben = benzyldimethylalkylammonium acetate

We claim:

1. A composition comprising:
(a) a dispersion of colloidal particles comprising silica or alumina particles in a solvent; and
(b) a biocide comprising an organic fungicide.

2. The composition of claim 1 wherein the colloidal particles are less than about 1 μm in at least one dimension.

3. The composition of claim 2 wherein the colloidal particles are less than about 100 nm in at least one dimension.

4. The composition of claim 1 wherein the organic fungicide is selected from a group consisting of fungicides active against wood-rotting basidiomycetes.

5. The composition of claim 1 wherein the organic fungicide comprises at least one of a conazole or an ergosterol biosynthesis inhibitor.

6. The composition of claim 5 wherein the conazole is selected from a group consisting of climbazole, clotrimazole, imazalil, oxpoconazole, prochloraz, triflumizole, azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, and uniconazole-P.

7. The composition of claim 5 wherein the ergosterol biosynthesis inhibitor is a morpholine fungicide selected from a group consisting of aldimorph, benzamorf, carbamorph, dimethomorph, dodemorph, fenpropimorph, flumorph, and tridemorph.

8. The composition of claim 4 wherein the organic fungicide comprises one or more fungicide of carboxin, iprodione, fenpiclonil, ferbam, fenpiclonil, capafol, 8-hydroxyquinoline, nabam, oxycarboxin, cyprodinil, chlorothanil, axaoxystrobin, trifloxystrobin, thiram, fluazinam, terrazole, carbendazim, or benomyl.

9. The composition of claim 1 wherein the organic fungicide is present at a concentration of from about 1 ppm to 10 wt %.

10. The composition of claim 1 further comprising an insecticide.

11. The composition of claim 10 wherein the insecticide comprises at least one of pyrazolines, indazoles, oxyindazoles, pyrazoline carboxanilides, pyridazines, oxadiazines, tricyclic pyridazines, tricyclic oxadiazines, tricyclic triazines, carbamates, organophosphates, fenvalerate, or fipronil.

12. The composition of claim 11 wherein the insecticide is indoxacarb (methyl (4aS)-7-chloro-2,5-dihydro-2-[[(methoxycarbonyl)[4-(trifluoromethoxy) phenyl]amino]carbonyl] indeno[1,2-e][1,3,4]oxadiazine-4a(3H)-carboxylate).

13. The composition of claim 10 wherein the insecticide is present at a concentration of from about 1 ppm to 10 wt %.

14. The composition of claim 1 wherein the solvent comprises a polar organic solvent, water, or mixtures of polar organic solvents and water.

15. The composition of claim 14 wherein the polar organic solvent further comprises hydroxy, ether, keto, or ester groups.

16. The composition of claim 1 further comprising fixing agents, softeners, emulsifiers, cross-linking agents, solution mediators, pigments, dyes, anti-corrosion agents, odor correctors, pH-regulators, UV-stabilizers, waxes, or drying oils.

17. A composition comprising:
(a) a dispersion of colloidal silica particles of less than about 1 μm in at least one dimension in a solvent and in a concentration of from about 0.3 wt % to about 5 wt %; and
(b) a biocide, present in a concentration of from about 1 ppm to 10 wt %, comprising at least one of a conazole or an ergosterol biosynthesis inhibitor and indoxacarb (methyl (4aS)-7-chloro-2,5-dihydro-2-[[(methoxycarbonyl)[4-(trifluoromethoxy) phenyl]amino]carbonyl] indeno[1,2-e][1 ,3,4]oxadiazine4a(3H)-carboxylate).

18. A process for preserving wood comprising
(a) contacting wood with a composition comprising:
i. a dispersion of colloidal particles comprising silica or alumina particles in a solvent; and
ii. one or more organic biocides comprising a fungicide, and
(b) transporting the composition with a sufficient driving force to penetrate the wood.

19. The process of claim 18 wherein the colloidal particles are less than about 1 μm in at least one dimension, and the fungicide is selected from a group consisting of fungicides active against wood-rotting basidiomycetes.

20. The process of claim 18 wherein the organic biocide further comprises an insecticide.

21. A wood product produced by the process of claim 18.

22. The wood product of claim 21 wherein the wood product is selected from a group consisting of oriented strand board, particle board, fiber board, plywood, laminated veneer lumber, laminated strand lumber, and handboard.
